(19) United States
(12) Patent Application Publication
(10) Pub. No.: US 2026/0058131 A1
(43) Pub. Date: Feb. 26, 2026

(54) METALLOID METAL OXIDE COATED BATTERY CATHODE

(71) Applicant: GEGADYNE ENERGY LABS PRIVATE LIMITED, Thane (West) (IN)

(72) Inventors: Ameya Pradeep GADIWAN, Mumbai (IN); Jubin Varghese KANNAMMOOTTIL, Mumbai (MH)

(21) Appl. No.: 19/105,618

(22) PCT Filed: Aug. 24, 2023
(86) PCT No.: PCT/IN2023/050798

§ 371 Date: Feb. 21, 2025

(30) Foreign Application Priority Data
Aug. 24, 2022 (IN) 202221048203

(51) Int. Cl. H01M 4/36; C01B 35/12; C23C 24/10; C25B 11/054; C25B 11/077; H01M 4/505; H01M 4/62; H01M 4/86; H01M 4/90; H01M 10/054

(52) U.S. Cl. CPC H01M 4/366; C01B 35/121; C23C 24/103; C25B 11/054; C25B 11/077; H01M 4/505; H01M 4/62; H01M 4/8657; H01M 4/9016; H01M 10/054; C01P 2004/84; C01P 2006/40

(57) ABSTRACT

The present invention generally discloses a metalloid metal oxide coating composition of Formula (I) for the alkali mixed metal oxide based battery cathode. The coating of said composition reduces reaction based degradation of the cathode as well as electrolyte, thereby improving performance, cycle life, and rate capacity of the battery. The present invention further relates to a method of preparing the coated cathode active material and process thereof.

### FIELD OF INVENTION

The present invention generally relates to a metalloid metal oxide coating composition of Formula (I) for the alkali mixed metal oxide based battery cathode. The coating of said composition reduces reaction based degradation of the cathode as well as electrolyte, thereby improving performance, cycle life, and rate capacity of the battery. The present invention further relates to a method of preparing the coated cathode active material.

### BACKGROUND & PRIOR ARTS

Rechargeable batteries have been the object of considerable research and development these days. The main aim is to develop economical battery, with high energy density and good electrochemical performance. Large number of battery designs have been developed to abide with different applications such as consumer electronics instruments, electric vehicles (EV) and start-light ignition (SLI) vehicles.

The cathode, the anode, the electrolyte and the separator are the main components of the battery. The cycle life, performance, and safety is dependent on the properties of these components. The cathode active material may comprise of material which can intercalate the metal ions. The electrolyte may contain one or more alkali metal ions, which is dissolved in a non-aqueous solvent. The anode material includes alkali ion insertion material, or alloying material. In particular, cathode as a component, and its properties, significantly determine the overall battery performance.

For long enough, the alkali metal oxide as cathode active material have been used for their advantageous characteristics that include charge density, battery capacity and such. In particular, lithium oxide as a cathode active material is most preferred choice. Several attempts were made in the past to arrive at the precise composition of the cathode in order to maximize its efficacy as well as longevity. It has been observed that the cathode degradation is one of the most important factors in gradually decreasing performance of the battery. In alkali-transition metal oxide cathode, dissolution of transition metal into the electrolyte, which leads to significant capacity loss during its running. Further, hydrofluoric acid (HF) is formed due to the presence of small amount of water in the electrolyte such as LiPF₆, which degrades the cathode and lowers the battery capacity. In fact, HF is widely considered as a battery poison due to its tendency to destroy the electrodes.

To counter the phenomenon of cathode degradation as well as interfacial instability in the transition metal ion-based alkali metal electrodes at high voltage, several ways were suggested and tried out. One of such solution is to provide coatings to the cathode. The surface coating of the cathode is extremely important since it helps in changing the surface chemistry as well as provides physical protection. The surface coating of the cathode material act as a barrier layer to reduce the direct contact between electrode and electrolyte, which obstruct electrolyte penetration along the grain boundary, thus repressing the side reactions at the interface, it also helps in protecting the surface from oxygen redox which occurs at high voltages, as well as prevent transition metal dissolution. The commonly used coating materials are oxides, which include Al₂O₃, MgO, TiO₂, LBO. The impact of surface coating on the performance of the cathode material includes modification of surface chemistry improves the overall performance, suppression of the metal dissolution, physical barrier impedes the side reactions between cathode material and the electrolyte.

Lately, borates based coatings were found to be effective in countering the negative impacts of HF formation and such. Following prior arts lists out borate based coatings applied to the lithium batteries or alkali batteries in general.

Zhou et al. “Stable, fast and high-energy-density LiCoO₂ cathode at high operation voltage enabled by glassy B₂O₃ modification” modified the cathode material with B₂O₃ thereby helping in achieving high voltage stability of LiCoO₂, also it enhanced the interfacial kinetics of the electrode by forming a particular SEI.

Erik A. Wu et al “A Facile, Dry-Processed Lithium Borate-Based Cathode Coating for Improved All-Solid-State Battery Performance” modified the surface of commercially available NCM811 using Boric acid toward longer-lasting and better-performing All-Solid-State Battery Performance (ASSBs).

Meili Du et al “Enhanced high-voltage cycling stability of Ni-rich LiNi_{0.8}Co_{0.1}Mn_{0.102} cathode coated with Li₂O—2B₂O₃” modified the surface of LiNi_{0.8}CO_{0.1}Mn_{0.102} with 0.3% Li₂O—2B₂O₃ and observed that the cycle retention after 100 cycles was 82.1% at 1C rate as against 50% for unmodified material. LBO coating helps in reducing the charge transfer resistance between the electrode and the electrolyte and also increase the cycling stability.

U.S. Pat. No. 10,439,212 relates to composite cathode materials which include those comprising an aluminum borate coating. The cathode active material comprises lithium and one or more of manganese, nickel, magnesium, aluminum, and cobalt. The aluminum borate compound coating provides a protective barrier against oxidative degradation of an electrolyte in contact with the composite cathode material when the cathode active material is charged using a voltage greater than 4.2 V.

U.S. Pat. No. 8,535,832 relates to active materials for positive electrodes for a lithium ion battery, in which the active material has a coating comprising a metal/metalloid oxide. In one of the aspect, the invention pertains to a lithium ion battery positive electrode material comprising a lithium metal oxide approximately represented by the formula Li₁₊ₓM₁₋ₓO_{2-z}F_{z}, where M is a non-lithium metal element or a combination thereof and 0.01≤x≤0.3, 0≤z≤0.2, coated with metal/metalloid oxide selected from aluminum oxide (Al₂O₃), bismuth oxide (BiO), boron oxide (B2O), Zirconium oxide (ZrO2), magnesium oxide (MgO), chromium oxide (Cr2O3), magnesium aluminate (MgAl2O4), gallium oxide (Ga2O3), silicon oxide (SiO2), tin oxide (SnO2), calcium oxide (CaO2), strontium oxide (SrO), barium oxide (BaO), titanium oxide (TiO2), iron oxide (Fe2O3), molybdenum oxide (MoO3, and MoO2), cerium oxide (CeO2), lanthanum oxide (La2O3), zinc oxide (ZnO). lithium aluminum oxide (LiAlO2), or combinations thereof. . . .

U.S. Pat. No. 10,374,262 provides cathode coatings for lithium ion batteries, cathodes coated with the coatings, and lithium ion batteries incorporating the coated cathodes. The coatings, which are composed of binary, ternary, and higher order metal oxides and/or metalloid oxides, can reduce the hydrofluoric acid (HF)-induced degradation of the electrolyte and/or cathodes, thereby improving the performance of lithium ion batteries, relative to lithium ion batteries that employ bare cathodes. The coating may include (i) a borate selected from TaBO₄, NbBO₄, Ca₅(BO₃)₃F, Mg₃(BO₃)₂, CaAlBO₄, and LiBO₂; or (ii) a phosphate selected from Mn₂PO₄F and CaSn₄(PO₄)₆; or (iii) a silicate selected from Li₂MgSiO₄, CaMgSiO₄, CaMgSi₂O₆, and Li₂SiO₃; or (iv) a metal oxide selected from WO₃, LiAl₅O₈, Li₃NbO₄, and BaSO₄; or (v) a metal oxide selected from Li₂CaSiO₄, CaIn₂O₄, Li₄H₃BrO₃, and Li₄H₃ClO₃; or (vi) a metal oxide selected from Li₂TiSiO₅, Ca₂Mn₃O₈, Li₂MnO₃, Ba₂TiSi₂O₈, and Ba₂Ti₄Fe₂O₁₄.

The present inventors felt that there is a scope in the art to provide the coating composition for alkali mixed metal oxide based battery cathode that improves the electrode performance, cycle life, rate capacity as well as the durability to a greater extent. This remains the objective of the invention.

### SUMMARY OF INVENTION

The present invention provides a coating composition selected from a metalloid metal oxide coated on cathode active material selected from alkali-transition metal oxide thereby improving performance, cycle life, and rate capacity of the battery.

In an aspect, the present invention provides metalloid metal oxide coating composition of Formula (I) for the alkali mixed metal oxide based battery cathode comprising;

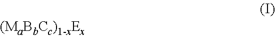

wherein, M represents one or more alkali metals selected from lithium, sodium or potassium;
‘B’ is a boron;
‘E’ represents a transition metal;
wherein 0≤a≤10, 0≤b≤10, 0≤c≤10;
x will be chosen such that its value will be in the range of 0.01≤x≤0.251, or more preferably 0.01≤x≤0.1 and ideally 0.01≤x≤0.05.

Accordingly, the coating composition of formula (I) comprises the borates which are compounds of boron, oxygen, and one or more additional metal and/or metalloid elements. Examples of borates include, for example, those having BO₃³⁻ groups, BO₄⁻ groups, dibroates (B₂O₅⁴⁻), triborates (B₃O₇⁵⁻), tetraborates (B₄O₉⁶⁻), and the like.

The composition of the coated material provides good compactness, and can effectively prevent a direct contact of an electrolyte and the cathode active material, thereby avoiding an oxidation-reduction side reaction. Moreover, alkali metal ion can effectively pass through the coating on the alkali ion-based cathode active material so as to achieve a migration of the alkali ions between the active material and the electrolyte.

The coating composition of formula I is coated on the cathode active material of the general formula (II)

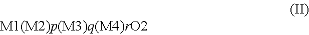

wherein M1, M2 and M3, M4 represents the alkali, alkaline or transition metals;
wherein ‘p’, ‘q’, ‘r’ are 0 or 1,
wherein said metal oxide has varying stoichiometric ratio.

Accordingly, the cathode active material of formula (II) is selected from a group consisting of lithium cobalt oxide, Sodium cobalt oxide, lithium nickel oxide, lithium/Sodium manganese oxide, lithium/Sodium/Potassium nickel cobalt oxide, lithium/Sodium/Potassium nickel manganese oxide, lithium/Sodium/Potassium nickel manganese oxide, with varying stoichiometric ratio.

In an aspect, the present invention provides a coated cathode composite comprising:

A cathode coating composition of formula (I)

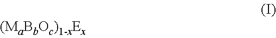

wherein, M represents one or more alkali metals selected from lithium, sodium or potassium;
‘B’ is a boron;
‘E’ represents a transition metal;
wherein 0≤a≤10, 0≤b≤10, 0≤c≤10;
x will be chosen such that its value will be in the range of 0.01≤x≤
0.251, or more preferably 0.01≤x≤0.1 and ideally 0.01≤x≤0.05; coated on to the cathode active material of formula (II)

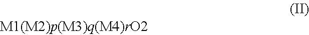

wherein,
M1, M2, M3 and M4 represents the alkali, alkaline or transition metals;
‘p’, ‘q’, ‘r’ are 0 or 1;
wherein said metal oxide has varying stoichiometric ratio.

In another embodiment, the cathode active material comprises of formula (III)

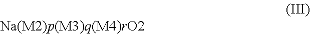

wherein M2, M3 and M4 represent the alkali, alkaline or transition metals,
wherein ‘p’, ‘q’ ‘r’ are 0 or 1;
wherein, said metal oxide has varying stoichiometric ratio.

The coated cathode material precursor may be particulate material having morphology spherical, rod, hexagonal, cubes and such.

In an aspect, the cathode active material may be coated with the coating composition of formula (I) by (i) Wet-chemical processes or (ii) solid state reaction.

According to the wet-chemical process the steps comprises;
(i) Dispersing the pristine cathode material of formula (II) in solvent to obtain the suspension;
(ii) Mixing the glassy coating composition of formula (I) in the concentration range of 0.1-10% into the above suspension;
(iii) Heating the above mixture until the solvent is removed to obtain the dry mixture; and
(iv) Sintering the dried mixture to a temperature in the range of 300-600° C. to yield the coated cathode material.

The desired stoichiometric amount of glassy coating composition for coating on to the positive electrode material by wet chemical synthesis approach is synthesized by the process comprising dissolving metal hydroxide and boric acid in the molar ratio 1:2 to 1:4 in the solvent selected polar protic or aprotic or non-polar solvent consisting of water, lower alcohols, ethers, nitriles, ketones, esters, hydrocarbons and the like alone or mixtures thereof. The mass ratio of the initial precursor will depend on the amount of coating required for the cathode material.

In another aspect, the process for solid state reaction process comprises;
(i) Dissolving metal hydroxide and boric acid in the molar ratio 1:2 to 1:4 in the solvent selected from polar protic or aprotic or non-polar solvents and the like alone or mixtures thereof followed by drying to obtain the powder of desired stoichiometric amount of the glassy coating composition;
(ii) Mixing the powder with the alkali metal ion-based cathode material of formula (II) in a weight ratio varying from 0.1% to 10%, and ball milled for uniform mixing wherein the solid content to the ball ratio is maintained around 1:40; and
(iii) Heating the above mixture at a temperature in the range of 400-600° C. to obtain the product.

In an aspect, the present invention provides an electrochemical cell/fuel cell comprising:
(i) Anode consisting of hard carbon;
(ii) A cathode composite comprising of cathode active material of Formula (II) or formula (III) coated with the coating composition of formula (I); Separator between the positive electrode and negative electrode; and
(iii) an Electrolyte

### BRIEF DESCRIPTION OF DRAWINGS

The following figures illustrate the method disclosed in the present specification, along with the advantages demonstrated through graphs.

FIG. 1 illustrates mechanism in the coated and uncoated electrodes during electrochemical testing.

FIG. 4 illustrates the electrochemical test result of the full cells with cathode composite comprising the cathode active material Na_{0.5}Ni_{0.25}Mn_{0.71}Ti_{0.04}O₂ coated with NBO for 20 cycles.

FIG. 5 illustrates electrochemical test result of the full cells having cathode active material Na_{0.5}Ni_{0.25}Mn_{0.71}Ti_{0.04}O₂ coated with NBO for 20 cycles.

FIG. 6 illustrates a cathode composite having 5% NBO coated Na_{0.5}Ni_{0.25}Mn_{0.71}Ti_{0.04}O₂ material with a capacity retention 98% after 20 cycles, indicating 0.1% loss per cycle.

### DETAILED DESCRIPTION OF THE INVENTION

The invention will now be described in detail in connection with certain preferred and optional embodiments, so that various aspects thereof may be more fully understood and appreciated. Unless specified otherwise, all technical and scientific terms used herein have the same meaning as commonly understood by one of ordinary skill in the art, to which this invention belongs. To describe the invention, certain terms are defined herein specifically as follows.

Unless stated to the contrary, any of the words, “including”, “includes”, “comprising”, and comprises” mean “including without limitation” and shall not be construed to limit any general statement that it follows to the specific or similar items.

The present invention discloses a coating composition selected from a metalloid metal oxide coated on cathode active material selected from alkali metal oxide thereby improving performance, cycle life, and rate capacity of the battery.

For the purpose of the present invention, the terms ‘alkali metal ion-based cathode’ and ‘cathode active material’ can be used interchangeably.

In an embodiment, the present invention discloses a coating composition of Formula (I) for the alkali mixed metal oxide based battery cathode comprising:

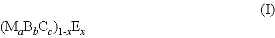

where M represents one or more alkali metals selected from lithium, sodium or, potassium;
‘B’ is a boron;
“E” represents a transition metal: wherein, 0≤a≤10 0≤b≤10, 0≤c≤10;
wherein, 0.01≤x≤0.251, preferably 0.01≤x≤0.1 and more preferably 0.01≤x≤0.05.

Accordingly, the coating composition of formula (I) comprises the borates which are compounds of boron, oxygen, and one or more additional metal and/or metalloid elements. Examples of borates include, for example, those having BO₃³⁻ groups, BO₄⁻ groups, diborates (B₂O₅₊), triborates (B₃O₇⁵⁻), or tetraborates (B₄O₉⁶⁻).

The composition of the coated material provides good compactness, and can effectively prevent a direct contact of an electrolyte and the cathode active material, thereby avoiding an oxidation-reduction side reaction. Moreover, alkali metal ion can effectively pass through the coating on the alkali ion-based cathode active material so as to achieve a migration of the alkali ions between the active material and the electrolyte.

In an embodiment, the coating composition of Formula I is coated on to the cathode active material represented by the general formula (II)

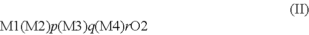

wherein M1, M2 and M3 represents the alkali, alkaline, or transition metals,
wherein ‘p’, ‘q’ ‘r’ are 0 or 1;
wherein said metal oxide has varying stoichiometric ratio.

Accordingly, the cathode active material of formula (II) is selected from a group consisting of lithium cobalt oxide, Sodium cobalt oxide, lithium nickel oxide, lithium/Sodium manganese oxide, lithium/Sodium/Potassium nickel cobalt oxide, lithium/Sodium/Potassium nickel manganese oxide, lithium/Sodium/Potassium nickel manganese titanium oxide, with varying stoichiometric ratio.

The coating is composed of a glassy material that hinders the side reaction and is ionically conductive.

In an embodiment, the present invention provides a coated cathode composite comprising:

A cathode coating composition of formula (I)

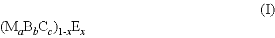

wherein, M represents one or more alkali metals selected from lithium, sodium or potassium;
‘B’ is a boron;
‘E’ represents a transition metal;
wherein 0≤a≤10, 0≤b≤10, 0≤c≤10;
x will be chosen such that its value will be in the range of 0.01≤x≤0.251, or more preferably 0.01≤x≤0.1 and ideally 0.01≤x≤0.05. coated on to the cathode active material of Formula (II)

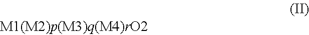

wherein M1, M2 and M3, M4 represents the alkali, alkaline or transition metals;
wherein ‘p’, ‘q’, ‘r’ are 0 or 1.
wherein said metal oxide has varying stoichiometric ratio.

In another embodiment, the cathode active material comprises of formula (III)

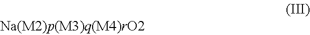

wherein M2, M3 and M4 represent the alkali, alkaline or transition metals.
wherein ‘p’, ‘q’ ‘r’ are 0 or 1;
wherein said metal oxide has varying stoichiometric ratio.

In an embodiment, the cathode active material is preferably Na_{0.5}Ni_{0.25}Mn_{0.71}Ti_{0.04}O₂.

In yet another embodiment, the present invention provides a coated cathode comprising Na₂O—B₂O₃ (NBO) coated Na_{0.5} Ni_{0.25} Mn_{0.71}Ti_{0.04}O₂.

In an embodiment, the cathode material may be coated with the coating composition of formula (I) by (i) Wet-chemical processes or (ii) solid state reaction.

According to the wet-chemical process, the steps comprises:
(i) Dispersing the pristine cathode material of formula (II) in solvent to obtain the suspension;
(ii) Mixing the glassy coating composition of formula (I) in the concentration range of 0.1-10% into the above suspension;
(iii) Heating the above mixture until the solvent is removed to obtain the dry mixture;
(iv) Sintering the dried mixture to a temperature in the range of 300-600° C. to yield the coated cathode material.

The desired stoichiometric amount of the glassy coating composition for coating on to the positive electrode material by wet chemical synthesis approach is synthesized by the process comprising dissolving metal hydroxide and boric acid in the molar ratio 1:2 to 1:4 in the solvent selected from polar protic or aprotic or non-polar solvent comprising of water, lower alcohols, ethers, nitriles, ketones, esters, hydrocarbons and the like alone or mixtures thereof. The mass ratio of the initial precursor will depend on the amount of coating required for the cathode material.

In another aspect, the solid state reaction process comprises:
(i) Dissolving metal hydroxide and boric acid in the molar ratio 1:2 to 1:4 in the solvent selected from polar protic or aprotic or non-polar solvents thereof followed by drying to obtain the powder of desired stoichiometric amount of the glassy coating composition;
(ii) Mixing the powder of step (i) with the alkali metal ion-based cathode material in a weight ratio varying from 0.1% to 10%, and ball milled for uniform mixing wherein the solid content to the zirconium ball ratio is maintained around 1:40; and
(iii) Heating at a temperature in the range of 400-600° C. to obtain the product.

The solid content refers to the mix of the coating material and the cathode active material which is then subjected to ball milling to obtain the uniform mixture.

The solvent for the process is selected from polar protic or aprotic or non-polar solvent consisting of water, lower alcohols, ethers, nitriles, ketones, esters, hydrocarbons and the like alone or mixtures thereof.

In an embodiment, the present invention discloses a coated cathode composite comprising a cathode active material of Formula (II) coated with a coating composition of Formula (I) in conjunction with a counter electrode and one or more electrolyte materials in energy storage devices.

For glassy coatings in which the coating is thin and/or the process of coating allows the reaction with the bulk of the cathode coating material, it can be advantageous to tailor coating material to the cathode active material being used. The coating of alkali ion-based cathode material with mixed glass material protects the material in at least three ways:
(i) By acting as a HF scavenger
(ii) By acting as a moisture barrier; and
(iii) Hindering dissolution of metal at high voltage.

The coating composition of formula (I) has good alkali ion penetration and low softening temperature. Generally, the coating composition of formula (I) melts at low temperature, which reduces the possibility of cathode active materials to become electrochemically inactive, thereby helping in maintaining high electrochemical discharge capacity. The resulting coating may comprise a steadier and even coating than coatings comprising inorganic oxide nano-particles.

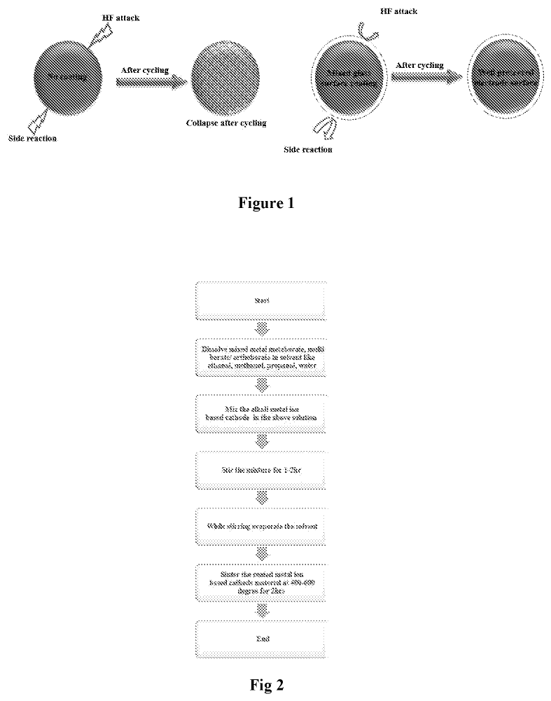

The glassy metalloid coating also helps in increasing the safety of the alkali metal ion battery when incorporated with the cathode material. FIG. 1 shows the reaction mechanism happening in the coated and uncoated electrodes during electrochemical testing.

In an embodiment, the amorphous glassy material may be insoluble in water and/or other solvent.

In a particular embodiment, the coating of desired the glassy coating composition onto the positive electrode material by wet chemical synthesis approach comprises synthesizing firstly, stoichiometric amount of the glassy coating composition by dissolving metal hydroxide and boric acid in the molar ratio 1:2 to 1:4 in the solvents selected from polar protic or aprotic or non-polar solvent consisting of water, lower alcohols, ethers, nitriles, ketones, esters, hydrocarbons and the like alone or mixtures thereof. The solution is kept for stirring for one hour. The mass ratio of the initial precursor will depend on the amount of coating required for the cathode material. The cathode material of formula (II) was dispersed in the solvents selected from polar protic or aprotic or non-polar solvent consisting of water, lower alcohols, ethers, nitriles, ketones, esters, hydrocarbons and the like alone or mixtures thereof. After one hour the dispersed cathode was mixed with solution mixture metal hydroxide and boric acid. The reaction mixture was stirred and the temperature of the reaction was maintained between room temperature to 90 degrees. Once the solvent was completely evaporated, the powder was collected and kept for sintering at a temperature ranging from 400 to 600° C. for 2 hrs to 10 hrs.

For glassy coatings in which the coating is thin and/or the process of coating allows the reaction with the bulk of the cathode coating material, it can be advantageous to tailor coating material to the cathode active material being used. The coating of alkali ion-based cathode material with mixed glass material protects the material, by acting as (i) a HF scavenger: (ii) a moisture barrier; and (iii) by hindering dissolution of metal at high voltage.

The composition of the coated material provides good compactness, and can effectively prevent a direct contact of an electrolyte and the cathode active material, thereby avoiding an oxidation-reduction side reaction. Moreover, alkali metal ion can effectively pass through the coating on the alkali ion-based cathode active material so as to achieve a migration of the alkali ions between the active material and the electrolyte.

In a preferred embodiment, the present invention discloses the sodium borate for example, those having BO₃³⁻ groups, BO₄⁻ groups, dibroates (B₂O₅₊), triborates (B₃O₇⁵⁻), tetraborates (B₄O₉⁶⁻), as coating composition for alkali mixed metal oxide based battery cathode with reduced reaction based degradation of the cathode as well as electrolyte, thereby improving performance, cycle life, and rate capacity of the battery.

In an embodiment, the present invention discloses the fuel cell comprising:
(i) Anode;
(ii) Cathode active material of Formula (II) or formula (III) coated with the coating composition of formula (I);
(iii) Separator between the positive electrode and negative electrode; and
(iv) an Electrolyte which is stable at high voltage

In an embodiment, the electrolyte used is an organic electrolyte containing 1M NaPF6 dissolved in the solvents selected from propylene carbonate (PC) and ethyl methyl carbonate (EMC), wherein PC:EMC is in 4:6 ratio. The said electrolyte is stable even at 4.5V.

In an embodiment, the alkali mixed metal oxide based cathode coated with the coating composition of formula (I) shows stability up to 20 cycles at voltage of 4.5V with 0.1% loss per cycle.

In yet another embodiment, the coated cathode composite of present invention find applications in alkali ion-cell, in energy storage devices such as batteries, rechargeable batteries, electrochemical devices and electrochromic devices.

In an embodiment, the coated cathode composite material of the present invention find application in alkali ion-cell, in energy storage devices such as batteries, rechargeable batteries, electrochemical devices and electrochromic devices, with said cathode composite arranged in series, parallel, or both.

Following examples demonstrate the advantages of the present invention and are presented to further explain the invention with experimental conditions, which are purely illustrative and are not intended to limit the scope of the invention.

### EXAMPLES

### Example 1: Synthesis of NBO-Coated Na_{0.5}Ni_{0.25}Mn_{0.71}Ti_{0.04}O₂ Wet Chemical Approach

This example demonstrates the coating of NBO onto the Na_{0.5}Ni_{0.25}Mn_{0.71}Ti_{0.04}O₂ electrode material by wet chemical synthesis approach. Firstly, 4 mg NaOH and 12.366 mg of H₃BO₃ were dissolved in methanol. The solution was stirred for two hours and gently heated at 70 degrees Celsius. In order to coat 5 wt % of NBO on Na_{0.5} Ni_{0.25} Mn_{0.71}Ti_{0.04}O₂, a 200 mg of cathode material is dissolved in methanol. The said solution is mixed with NaOH+H₃BO₃ solution, and gently heated to evaporate methanol. The dried mixture is crushed in a mortar pastel and then mixture is heated at 500 degrees for 10 hrs.

### Example 2: Synthesis of NBO-Coated Na_{0.5}Ni_{0.25}Mn_{0.71}Ti_{0.04}O₂ Using Solid State Synthesis Approach

Na₂O—B₂O₃ (NBO) was synthesized by mixing 7 gm of NaOH and 21.63 gm of H₃BO₃ and dissolving in methanol. The mixture was kept for stirring for two hrs and then stirring slowly at temperature of 70° C. The dried powder was crushed. 5% of the NBO powder was mixed with the appropriate amount of Na_{0.5}Ni_{0.25}Mn_{0.71}Ti_{0.04}O₂. The mixture was ball milled for approximately 2 hrs. The ratio of the solid content to the zirconium ball ratio was maintained 1:40 in order to achieve uniform mixing. The mixture was heated in the furnace at 500° C. for 10 hrs.

### Example 3: Battery Performance of Uncoated Na_{0.5}Ni_{0.25}Mn_{0.71}Ti_{0.04}O₂

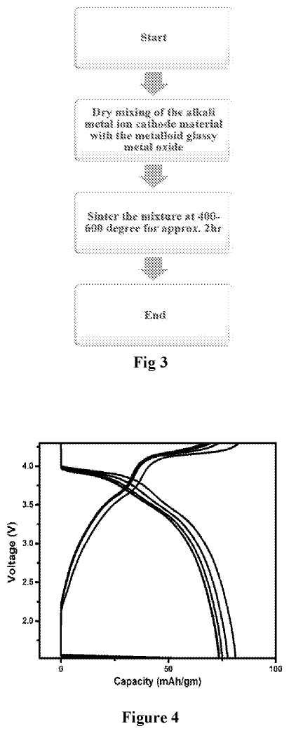

Na_{0.5}Ni_{0.25}Mn_{0.71}Ti_{0.04}O₂, was mixed uniformly with carbon black in the desired ratio, preferably 90:5:5. Polyvinylidene fluoride solution was made using N-methyl-pyrrolidone (NMP) as solvent. The homogeneous powdered mixture was added to PVDF solution maintaining the ratio 90:5:5. The mixture was vacuum mixed for 1 hr to get a homogeneous slurry. The slurry was coated in the Aluminum current collector using the doctor blade technique. Both coated electrodes were dried overnight in a vacuum oven to remove moisture. Full cells were made by using hard carbon as anode material. Electrolyte which will remain stable at high voltage was chosen. 2032 coin cell geometry full cell was fabricated inside the glovebox using Na_{0.5}Ni_{0.25}Mn_{0.71}Ti_{0.04}O₂ as cathode and hard carbon as anode. FIG. 4 shows the electrochemical test result of the full cells made using NBO-coated Na_{0.5}Ni_{0.25}Mn_{0.71}Ti_{0.04}O₂. From FIG. 4, it is evident that the full cell which was made using uncoated Na_{0.5}Ni_{0.25}Mn_{0.71}Ti_{0.04}O₂ cathode is less stable at higher voltage up to 4.3V.

### Example 4: Battery Performance with NBO-Coated Na_{0.5}Ni_{0.25}Mn_{0.71}Ti_{0.04}O₂

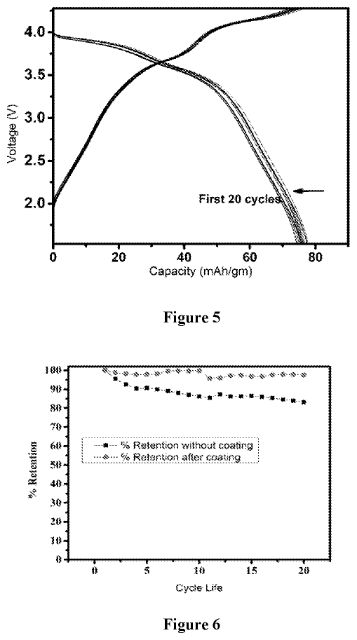

To test the performance of NBO-coated Na_{0.5}Ni_{0.25}Mn_{0.71}Ti_{0.04}O₂, the material was mixed uniformly with carbon black in the desired ratio i.e 90:5:5. Polyvinylidenefluoride solution was made using N-methyl-pyrrolidone (NMP) as solvent. The homogeneous powdered mixture was added to PVDF solution maintaining the ratio 90:5:5. The mixture was vacuum mixed for 1 hr to get a homogeneous slurry. The slurry was coated in the Aluminum current collector using the doctor blade technique. Both coated electrodes were dried overnight in a vacuum oven to remove moisture. Full cell was made by using hard carbon as anode material. Electrolyte which will remain stable at high voltage was chosen preferably 1MNaPF6 dissolved in PC and EMC in 4:6 ratio. 2032 coin cell geometry full cell was fabricated inside the glove box using NBO-coated Na_{0.5}Ni_{0.25}Mn_{0.71}Ti_{0.04}O₂ as cathode and hard carbon as anode. FIG. 5 shows the electrochemical test result of the full cells made using NBO-coated Na_{0.5}Ni_{0.25}Mn_{0.71}Ti_{0.04}O₂. From FIG. 5 it is evident that the full cell which was made using NBO-coated Na_{0.5}Ni_{0.25}Mn_{0.71} Ti_{0.04}O₂ cathode was more stable at higher voltage up to 4.3V. FIG. 6 illustrates that 5% NBO coated Na_{0.5}Ni_{0.25}Mn_{0.71}Ti_{0.04}O₂ material has a capacity retention of 98% after 20 cycles, indicating 0.1% loss per cycle, a significant improvement over the uncoated example of the same material.

I/We claim:

1. A coating composition of metalloid metal oxide of Formula I coated on to alkali metal oxide cathode active material
comprising; 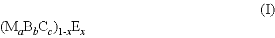
wherein, M represents one or more alkali metals selected from lithium, sodium or potassium;
‘B’ is a boron;
‘E’ represents a transition metal;
wherein, 0≤a≤10, 0≤b≤10, 0≤c≤10;
x is in the range of 0.01≤x≤0.251, or more preferably 0.01≤x≤0.1 and ideally 0.01≤x≤0.05.

2. The coating composition as claimed in claim 1, wherein said coating composition comprises borates selected from the group consisting of BO₃³⁻ groups, BO₄⁻ groups, diborates (B₂O₅⁴⁻), triborates (B₃O₇⁵⁻), or tetraborates (B₄O₉⁶⁻).

3. The coating composition as claimed in claim 1, wherein said coating composition is a glassy material.

4. The coating composition as claimed in claim 1, wherein cathode active material of metal oxide of Formula II comprising; 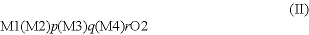
wherein, M1, M2, M3 and M4 selected from alkali, alkaline, or transition metals;
wherein ‘p’, ‘q’ ‘r’ are 0 or 1;
wherein said metal oxide has varying stoichiometric ratio.

5. The coating composition as claimed in claim 4, wherein the metal oxide is selected from a group consisting of lithium cobalt oxide, Sodium cobalt oxide, lithium nickel oxide, lithium/Sodium manganese oxide, lithium/Sodium/Potassium nickel cobalt oxide, lithium/Sodium/Potassium nickel manganese oxide, lithium/Sodium/Potassium nickel manganese titanium oxide, with varying stoichiometric ratio.

6. The coating composition as claimed in claim 4, wherein the cathode active material of metal oxide of Formula III comprising; 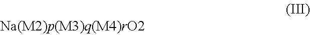
wherein, M2, M3 and M4 selected from alkali, alkaline, or transition metals;
wherein ‘p’, ‘q’ ‘r’ are 0 or 1;
wherein said metal oxide has varying stoichiometric ratio.

7. A coated cathode composite comprising:
coating composition of formula (I) 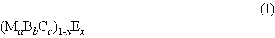
wherein, M represents one or more alkali metals selected from lithium, sodium or potassium;
‘B’ is a boron;
‘E’ represents a transition metal;
wherein 0≤a≤10, 0≤b≤10, 0≤c≤10;
x will be chosen such that its value will be in the range of 0.01≤x≤0.251, or more preferably 0.01≤x≤0.1 and ideally 0.01≤x≤0.05;
coated on to the cathode active material of formula (II) 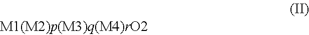
wherein,
M1, M2, M3 and M4 represents the alkali, alkaline or transition metals;
‘p’, ‘q’, ‘r’ are 0 or 1;
wherein said metal oxide has varying stoichiometric ratio.

8. A process for coating the cathode active material as claimed in claim 1 comprising (i) Wet-chemical process or (ii) solid state reaction.

9. The process as claimed in claim 8, wherein the wet-chemical process comprises:
i. Dispersing the pristine cathode material of formula (II) or Formula (III) in a solvent to obtain the suspension;
ii. Mixing the glassy coating composition of formula (I) into the above suspension in the concentration range of 0.1-10%;
iii. Heating the above mixture until the solvent is removed to obtain the dry mixture; and
iv. Sintering the dried mixture to a temperature in the range of 300-600° C. to yield the coated cathode material.

10. The process as claimed in claim 9, wherein the glassy coating composition of step (ii) is prepared by dissolving metal hydroxide and boric acid in the molar ratio 1:2 to 1:4 in a solvent.

11. The process as claimed in claim 9, wherein the solvent for the process is selected from polar protic or aprotic or non-polar solvents comprising of water, lower alcohols, ethers, nitriles, ketones, esters, hydrocarbons and the like alone or mixtures thereof.

12. The process as claimed in claim 8, wherein solid state reaction comprises the steps of:
i. Dissolving metal hydroxide and boric acid in the molar ratio 1:2 to 1:4 in the selected from polar protic or aprotic or non-polar solvents followed by drying to obtain the powder of desired stoichiometric amount of glassy coating composition;
ii. Mixing the powder of step (i) with the cathode active material in a weight ratio ranging from 0.1% to 10% and ball milled for uniform mixing wherein the solid content to the ball ratio is maintained at 1:40; and
iii. Heating at a temperature in the range of 400-600° C. to obtain the product.

13. The coating composition as claimed in any of the preceding claims comprising; coating the cathode active material Na_{0.5}Ni_{0.25}Mn_{0.71}Ti_{0.04}O₂ with Na2O—B2O3 (NBO); K2O:B2O3; NaKO:B2O3 and the like.

14. Use of the coated cathode active material as claimed in claim 1, for electrochemical/fuel cells, alkali ion-cell, in energy storage devices such as batteries, rechargeable batteries, electrochemical devices and electrochromic devices.

15. The coated cathode active material as claimed in claim 1, wherein, said cathode shows stability up to 20 cycles at voltage of 4.5V with 0.1% loss per cycle.

16. A method of electrolysis in the electrochemical/fuel cells comprising the use of the coated cathode active material as claimed in claim 1.

17. A fuel cell comprising:
(i) Anode;
(ii) Cathode active material of Formula (II) or formula (III) of claim 4 or claim 6 coated with the coating composition of formula (I) claimed in claim 1;
(iii) Separator between the positive electrode and negative electrode; and
(iv) An Electrolyte which is stable at high voltage.
